(19) United States
(12) Patent Application Publication
(10) Pub. No.: US 2009/0109589 A1
(43) Pub. Date: Apr. 30, 2009

(54) HIGH SPEED AUTOMATIC CIRCUIT BREAKER FOR PROTECTION

(76) Inventors: Jea Sik Yoo, Seoul (KR); Jeong Ryoul Yi, Seoul (KR); Ieel Ho Seol, Jellabuk-do (KR); Ju Uk Lee, Gyeonggi-do (KR); Hyun Ho Cho, Chungcheongnam-do (KR)

Correspondence Address: BLAKELY SOKOLOFF TAYLOR & ZAFMAN LLP, 1279 OAKMEAD PARKWAY, SUNNYVALE, CA, 94085-4040, US

(21) Appl. No.: 12/295,222

(22) PCT Filed: Mar. 17, 2007
(86) PCT No.: PCT/KR2007/001221

§ 371 Date: Nov. 4, 2008

(30) Foreign Application Priority Data
Mar. 30, 2006 (KR) 10-2006-0028998

(51) Int. Cl. H02H 9/02

(52) U.S. Cl. 361/93.1

(57) ABSTRACT

Disclosed is a high speed automatic circuit breaker in which a Rogowski coil is integrated with a voltage sensor, a microprocessor processes voltage and current signals through an electronic transformer to reduce a size and costs, and an algorithm of counting, charging, and trip is realized for coordination with reclosers of a power substation and a line. The circuit breaker includes a main body to receive an electric power when fixed and moving contacts contacting each other, to operate the moving contact using an trip coil according to a trip control signal to trip, and to input the electric power according to an closing control signal, and a control unit to monitor current of a lead-in line and voltage to generate a control signal of controlling the main body. Thus, costs and installing space can be reduced and a customer fault is fundamentally prevented from being propagated to the line.

### TECHNICAL FIELD

The present invention relates to a power receiving main circuit breaker installed inside a customer, and more particularly, to a high speed automatic circuit breaker, in which a circuit breaker, an electronic voltage transformer, and an electronic current transformer are integrated, to prevent an accident in the customer from propagating to a power line in good protection coordination with an electric power substation and a recloser on the power line and to protect equipments in the customer.

### BACKGROUND ART

Generally, in order to supply electric power to customers, a relative long power transmission line is required. In this case, the power loss is inevitably generated caused by electric resistance of an electric power transmission line. In order to reduce the power transmission loss, a thick electric wire is used to reducing the electric resistance or to increasing the transmission line voltage. Thus, generally the transmission line voltage of an electric generator is supplied up to approximately 66,000 V, 154,000 V and 345,000 V as transmission line voltages, and distribution line voltage of electric power substation in the vicinity of customers is served to chiefly, 22,900 V.

On the other hand, in a multiple neutral ground type 22.9 kV distribution system, as a conventional main circuit breaker for protecting a customer, as illustrated in FIGS. 1 and 2, a device in which a power fuse (PF) and an automatic section switch (ASS) or a circuit breaker (CB).

However, since these devices activate a recloser in the distribution line or are permanently opened when an accident occurs in the customer, a trouble occurred in the customer is frequently propagated to the line so that the fault area is widened or power failure time is extended.

FIG. 1 is a conventional standard wiring diagram for a special high voltage power receiving unit, and FIG. 2 is a conventional standard wiring diagram for a simplified special high voltage power receiving unit.

According to the conventional standard wiring diagram in FIG. 1, after a disconnect switch (DS) is installed at a first service entrance end of the customer, electric power is served through a power fuse (PF) and a metering out fit (MOF) and power meters (D/M and VAR) are installed sequentially. The electric power passing through the metering out fit (MOF) is supplied to respective customers through the circuit breaker (CB) and in order to protect the distribution system from a phase fault or a ground fault, voltages and currents are detected by a potential transformer (PT) and a current transformer (CT) to control the circuit breaker (CB) and a trip coil (TC) with an overcurrent relay (OCR), an overcurrent ground relay (OCGR), an undervoltage relay (UVR) and an overvoltage relay (OVR).

Moreover, according to the conventional standard wiring diagram in FIG. 2, after a sectionalizer or an automatic section switch (ASS) is installed at a disconnect switch (DS) installed at a first service entrance end of the customers, the electric power is served through a power fuse (PF) and a metering out fit (MOF) and power meters (D/M and VAR) are installed sequentially.

The automatic section switches (ASS) depicted in FIGS. 1 and 2 are device to rapidly and correctly interrupt or open only a fault section and automatically separate the fault section in coordination with the circuit breaker (CB) of the electric power substation and a recloser installed in the distribution line in order to improve reliability of the power supply and to prevent short circuit of many other customers.

The disconnect switch (DS) is a device used to switching a charged power line and to separating the charged power line by opening and closing to check or repair an electric facility in the electric power substation. The circuit breaker (CB) is a kind of a power opening and closing device and a device used to making and tripping an abnormal power line other than a normal power line, more particularly, a phase fault power line or ground fault power line.

The circuit breaker (CB) is categorized into an oil circuit breaker, a magnetic blast circuit breaker, an air blast circuit breaker, an SF6 gas blast circuit breaker and a vacuum circuit breaker. A lightning arrester (LA) is a device to protect principal facilities from overvoltage due to lightning stroke or switching surge.

However, according to a conventional wiring method between the power fuse (PF) and the automatic section switch (ASS) (See FIG. 2), the automatic section switch (ASS) directly clears the fault in a section where the fault current is lower (equal to or less than 900 A) and a backup protection device clears the fault using a charging trip function and separates the fault section prior to the reclosing in a section where the fault current is high or when the recloser firstly clears the fault. Since the automatic section switch (ASS) cannot eliminate a short circuit current, it must wait for the backup protection device to eliminate the fault when the fault current is high.

Moreover, in a case of using the circuit breaker (CB) (See FIG. 1), a circuit breaker (CB), a current transformer (CT), a power fuse (PF), and a three-phase transformer (PT), which are separated from each other, are independently installed, and various meters such as an overcurrent relay, an overcurrent ground relay, an overvoltage relay, and an undervoltage relay assist the backup protection device to protect. In Korea, in order to improve loss of the current transformer (CT), a metering out fit (MOF) for metering electric power is installed in a power source of the circuit breaker (CB) and a power fuse (PF) is installed to protect the metering out fit (MOF). However, these installations make the circuit breaker (CB) a useless thing and cannot prevent the fault at the customer from propagating to the line due to a problem in coordination with the power fuse (PF) and the backup protection device. In order to improve the above-problem, it is configured to use the automatic section switch or the sectionalizer instead of the disconnect switch (DS) at the service entrance. However, the coordination with the backup protection device is partially improved by the charging trip function, but the propagation of the fault to the line cannot be prevented and the circuit breaker (CB) becomes a useless thing.

In order to solve the above-problem, it is necessary that the metering out fit (MOF) can be installed to a load side of the circuit breaker (CB) by integrating a voltage sensor and a current sensor, having negligible losses into the circuit breaker (CB) and installing the circuit breaker (CB). Since this electronic transformer has a very lower burden, the electronic transformer is required to be connected to a microprocessor through a matching circuit having input impedance. Moreover, in order for the coordination with the circuit breaker (CB) of the electric power substation and the recloser of the line, it is required to minimize time for eliminating a fault of a main body of the circuit breaker (CB). And it needs a new protecting coordination algorithm using a counting function and a charging function.

### DISCLOSURE OF INVENTION

### Technical Problem

Therefore, the present invention has been made in view of the above problems, and it is an aspect of the present invention to provide a high speed automatic circuit breaker in which a current transformer uses a Rogowski coil, a differentiated current signal is matched with the microprocessor through a digital integration algorithm, a resistive sensor is used as a voltage transformer to improve dielectric characteristics and accuracy, a counting function and a charging function are added to an overcurrent relay, a voltage relay, and a reclosing relay.

### Technical Solution

In accordance with an aspect of the present invention, the above and other objects can be accomplished by the provision of a circuit breaker comprising a circuit breaker main body to receive an electric power when fixed and moving contacts contacting each other, to operate the moving contact using an trip coil according to a trip control signal to trip, and to input the electric power according to an closing control signal and a circuit breaker control unit to monitor current of a lead-in line and voltage to generate a control signal of controlling the circuit breaker main body.

Here, the circuit breaker main body is integrally formed with a Rogowski coil to detect current and a resistive voltage sensor to detect voltage, and the Rogowski coil includes an end of a coil wound around a plastic core to return through a groove formed in the plastic core, and the coil has an outer side magnetically shielded and an inner side electrically shielded.

The circuit breaker control unit comprises: an analog filter to filter a current detected in the circuit breaker main body; an analog-to-digital converter to convert the detected analog signals into digital signals; a preprocessing unit to perform a digital integration of the detected current converted into the digital detected current, an adjustment of a DC offset, and a compensation of an induced current; a digital filter unit to filter the preprocessed current value; an analog filter to filter a voltage detected in the circuit breaker main body; an analog-to-digital converter to convert the analog detected voltage into a digital detected voltage; a digital filter to filter the detected voltage converted into the digital value; and a controller to compare the filtered current with a current threshold value and the filtered voltage with an overvoltage threshold value to perform a fast overcurrent relaying function, a delay overcurrent relaying function, a charging and counting function, a measuring function, an overvoltage relaying function, an undervoltage relaying function, and a reclosing relaying function, and provides the counting function, the charging function, and the trip function to the general overcurrent relaying function, the general overcurrent ground relaying function, the general reclosing relaying function, the general overvoltage relaying function, and the general undervoltage relaying function so as to take the place of coordinate with a recloser in a line without installing a sectionalizer or an automatic section switch.

### Advantageous Effects

According to the present invention, an overcurrent relaying unit and an overcurrent ground relaying function unit can prevent cold load pickup because of having both of a fast characteristic and a delay characteristic, can coordinate with a fast operation of a recloser, and operate the circuit breaker of the present invention to fundamentally prevent a power interruption caused by operation of the recloser due to fault occurred in the customer when the accident occurs in the customer.

Moreover, since the high speed automatic circuit breaker of the present invention operates fast, the circuit breaker can coordinate with the recloser when the recloser operates instantaneously. Since the malfunction can be eliminated after the recloser is operated once by the charging and counting functions when a control unit of the present invention is employed in a general circuit breaker, it does not need to install a sectionalizer or an automatic section switch.

Furthermore, since the circuit breaker of the present invention has both of an overcurrent relaying function and an undervoltage relaying function and does not perform a non-voltage opening when the backup protection units clears the fault and the accident is not occurred in the customer, and thus undesired time and efforts are not required at the repressing.

The circuit breaker may be employed in the customer or in the line, and functions as a circuit breaker using a counting function in a sequence prior to a final counting to reduce a onetime wide area line interruption in comparison to a load switch.

A restive sensor of the Rogowski coil is characterized by a low loss and a high accuracy and is installed in a main body of the circuit breaker without an additional protector such that a metering out fit can be installed to a load side of the circuit breaker, and thus a better protection coordination is enabled without a sectionalizer, an automatic section switch, a power fuse, or a three-phase transformer. Therefore, the customer can reduce the installing space and costs and an electric power company can fundamentally prevent the customer accident from being propagated to the line.

### BRIEF DESCRIPTION OF THE DRAWINGS

FIG. 1 is a conventional standard wiring diagram for a special high voltage power receiving unit;

FIG. 2 is a conventional standard wiring diagram for a simplified special high voltage power receiving unit;

FIG. 3 is a receiving end wiring diagram using a circuit breaker according to an embodiment of the present invention;

FIG. 4 is a Rogowski coil according to the embodiment of the present invention;

FIG. 5 is a resistive voltage sensor according to the embodiment of the present invention;

FIG. 7 is a block diagram illustrating the circuit breaker according to the embodiment of the present invention; and

FIG. 8 is a control algorithm of the circuit breaker according to the embodiment of the present invention.

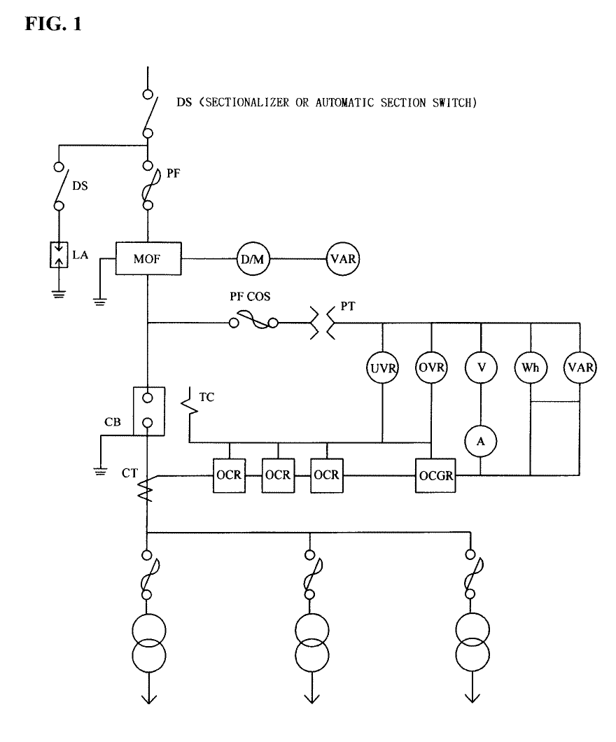

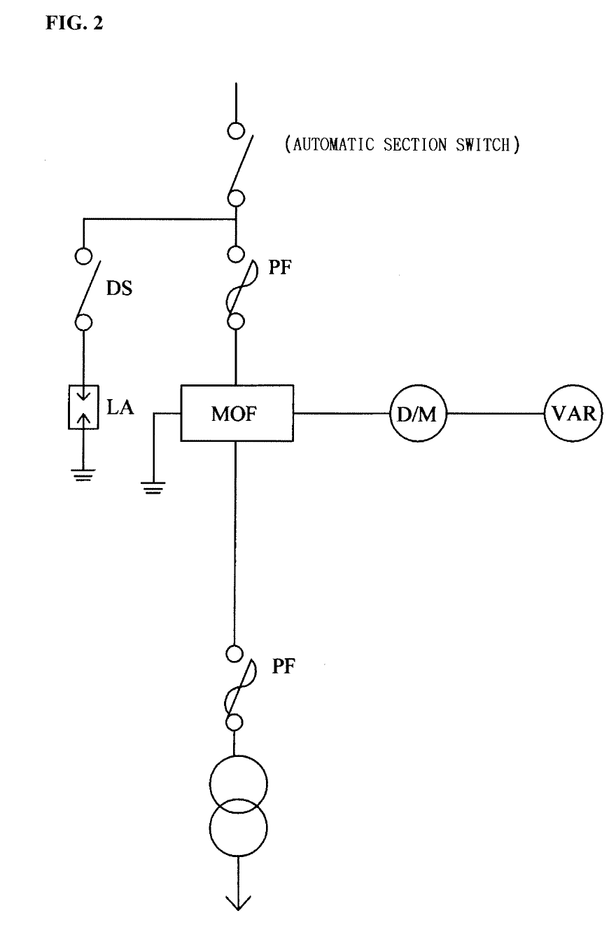

### BEST MODE FOR CARRYING OUT OF THE INVENTION

Hereinafter, embodiments of the present invention will be described in detail by reference to the accompanying drawings.

First, an interruption in an alternating current circuit breaker means that, since a current zero appears every half cycle and a direction of the current is reversed, a chance of the current zero is used as possible as much and arc energy is effectively extinct. Generally, the alternating current circuit breaker is categorized into one of combining a switch for air-switching and a fuse, and an oil circuit breaker, an air circuit breaker, and a magnetic circuit breaker, different from each other in an interruption theory and extinction medium. Presently, a SF6 gas circuit breaker and a vacuum circuit breaker are widely used.

The SF6 gas circuit breaker is a circuit breaker using an excellent insulation performance and a cooling performance of SF6 gas. The vacuum circuit breaker is configured that contacts contact each other within a vessel (a vacuum valve) maintaining high vacuum lower 10 Torr, has high insulation strength at a narrow gap in the high vacuum condition, and has an excellent interruption performance because of a fast propagation of metal vapor generated from the arc.

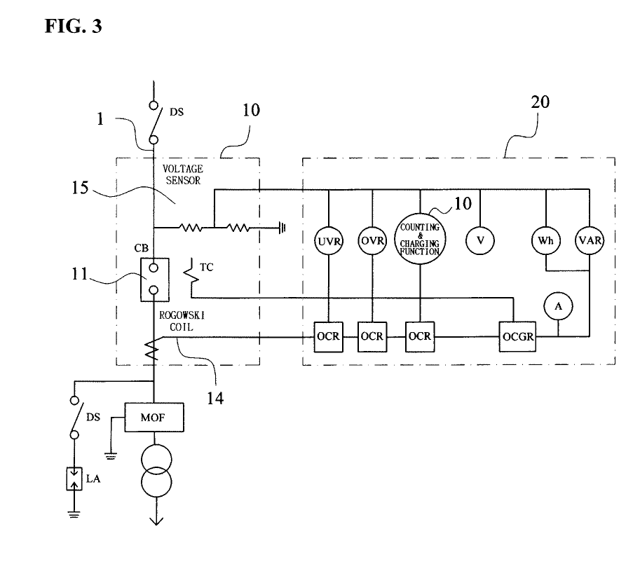

FIG. 3 is a receiving end wiring diagram using a high speed automatic circuit breaker according to an embodiment of the present invention.

According to the receiving end wiring diagram in FIG. 3, a disconnect switch (DS) is installed at a first service entrance end of a customer, and it can be understood that an electric power passing through the disconnect switch (DS) is supplied to customer's devices via a main body (10) of the circuit breaker (CB) according to the embodiment of the present invention and a metering out fit (MOF). Although not depicted in the drawing, the main body (10) of the circuit breaker includes a fixed contact, a moving contact, a closing coil, a trip coil, an extinction method. Particularly, a Rogowski coil (14) serving to as a current transformer in the present invention and a resistive voltage sensor (15) serving to as a voltage transformer are integrally formed in the main body (10) of the circuit breaker.

Moreover, the main body (10) of the circuit breaker is connected to a circuit breaker controlling unit (20) in order to protect a distribution system from a phase fault or a ground fault. The circuit breaker controlling unit (20), as described later, is realized by a microprocessor so that an overcurrent relay (OCR) function, an overcurrent ground relay (OCGR) function, an undervoltage relay (UVR) function, an overvoltage relay (OVR) function, a counting and charging function (26), a current meter (A) function, a voltage meter (V) function, and a power meter (Wh and VAR) function are processed by a software to control a trip operation of the circuit breaker.

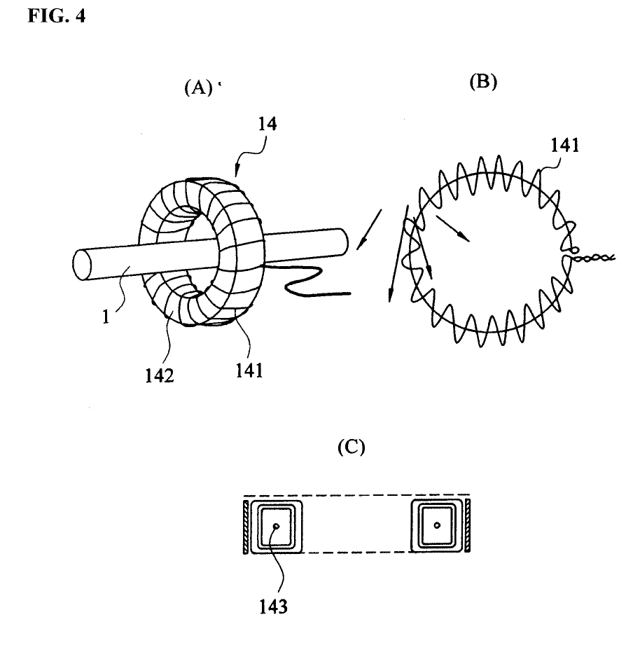

FIG. 4 is a view illustrating a Rogowski coil according to the embodiment of the present invention, in which FIG. 4A is a perspective view illustrating a Rogowski coil (14) wound around a distribution wire (1) in the form of a cylindrical shape, FIG. 4B is a schematic view illustrating a winding shape and a returning method of a coil (141) via inner grooves, and FIG. 4C is a side sectional view illustrating the Rogowski coil (14).

Generally, since the Rogowski coil employs an air core, different from a current transformer using a general metal core, the Rogowski coil is considered as an ideal current transformer which has no exciting current and is not saturated even when a large current flows. However, since a current signal is differentiated, a precise analog integrator is required, and a burden is very low, the Rogowski coil is not matched with a general electromechanical relay and a general electronic relay and is restrictively used in a part of ultra high voltage switchgear. Moreover, the Rogowski coil causes a magnetic induction when a current flows through a current path in the vicinity thereof and has a relative high electrostatic induction due to a voltage.

Thus, the present invention provides a device to solve the magnetic and electrostatic induction when a low-loss and high precision Rogowski coil is integrated into a circuit breaker with a limited size, and to compensate a phase and a size using a digital integrator or a digital filter algorithm for overcoming a difficulty of utilizing an analog integrator.

Referring to FIG. 4, in the Rogowski coil (14) according to the embodiment of the present invention, an end of the coil (141), wound around a plastic core (142), returns via inner grooves (143), an outer side thereof is magnetically shielded, and the inside thereof is electrically shielded. An output end of the coil (141) is connected to a shield cable, and a shield layer is connected to an electric shield to be grounded to a metal case of the circuit breaker. As such, in order to prevent the electrostatic induction of the Rogowski coil (14), it is required to electrically shield the Rodowski coil. Moreover, in order to prevent the magnetic induction, it is required to return one end of the ring-shaped Rogowski coil wound in the coil shape to the inside of the coil.

On the other hand, an output of the Rogowski coil (14) is expressed by the following formula (1) and a minus differential value with respect to an input current.

$$V = - M \frac{d i}{d t} \qquad [ Formula 1 ]$$

If three-phase currents are I_{A}, I_{B} and I_{C} and sample values of the Rogowski coil (14) are V_{RA1}, V_{RA2}, . . . , V_{RAN-1}, V_{RAN}, V_{RAN+1}; V_{RB1}, V_{RB2}, . . . , V_{RBN-1}, V_{RBN}, V_{RB+1}; V_{RC1}, V_{RC2}, . . . , V_{RCN-1}, V_{RCN}, V_{RCN+1}, intermediate values of the sequential sample values are selected in order to avoid phase-transitions and the selected intermediate values are integrated so that the phase-transitions disappears and sizes of the selected sample values have predetermined ratio errors and are compensated during the estimations performed by the following formulas (2) to (4).

$$\begin{matrix}{I}_{AN} = - Q ( \frac{{V}_{RAN} + {V}_{RAN - 1}}{2} ) S \frac{1}{T} & [ Formula 2 ] \\ {I}_{BN} = - Q ( \frac{{V}_{RBN} + {V}_{RBN - 1}}{2} ) S \frac{1}{T} & [ Formula 3 ] \\ {I}_{CN} = - Q ( \frac{{V}_{RCN} + {V}_{RCN - 1}}{2} ) S \frac{1}{T} & [ Formula 4 ]\end{matrix}$$

where T is a sample number per one second.

Induced currents due to adjacent current paths are restricted by a winding method and a magnetic shield of the Rogowski coil, but a part of the induced currents may be generated.

Factors induced in the A-phase by the B-phase current and the C-phase current are determined by experiments and are set to KBA and KCA, respectively, then

V′_{RAN}=V_{RAN}−K_{BA}V_{RBN}−K_{CA}V_{RCN}

In the same manner, if factors induced on the B-phase by the A-phase and the C-phase and factors induced on the C-phase by the A-phase and the B-phase are set to KAB and KCB, and KAC and KBC, respectively, then

V′_{RBN}=V_{RBN}−K_{AB}V_{RAN}−K_{CB}V_{RCN}

V′_{RCN}=V_{RCN}−K_{AC}V_{RAN}−K_{BC}V_{RBN}

so that the compensations can be performed by simple estimations.

In the integrator, when a direct current offset current is generated by an initial value where the integration is beginning or due to a phase fault in a system, a case where the direct current offset current is not sampled may be generated. Since the digital integrator memorizes this case as an off-set, the digital integrator must be periodically reset. Generally, since a digital filter in a relay extracts only a fundamental wave, a direct current off-set is not effective but it is required to prevent the integrator from being saturated.

In order to remove the DC off-set appeared in the integrator, a sum of two data separated by electrical 180 degrees is obtained, and the sum is divided by 2 and subtracted from a currently integrated value.

For example, if samplings are 16 per one cycle, then it is given by

$${I}_{A , N} = {I}_{AN} - \frac{{I}_{AN} + {I}_{AN} - 7}{2}$$

A method of compensating the phases and sizes without using the integrator is as follows.

If a line current is Iₗ=cos ωl, then the output of the Rogowski coil is I_{rc}∝ω sin ωt.

Since

$${I}_{l} = cos ω t = \frac{ωsin ( ω t + 90 )}{ω} ,$$

an actual line current transits the output value of the Rodowski coil by 90 degrees and is proportional to a value divided by ω.

Generally, since the relay works to extract only the basic wave, the digital filter easily transits the sample data by 90 degrees and the rest is processed as a constant. Needless to say, the algorithm for compensating the induced current is required in this case, too.

As described above, the present invention provides the Rodowski coil (14) as a current sensor integrated in the circuit breaker main body (10), an electric and magnetic shield type Rogowski coil to be matched with the microprocessor, the compensation of the magnetic induction, a digital integration algorithm, and a reset method and a non-integration algorithm of the digital integrator.

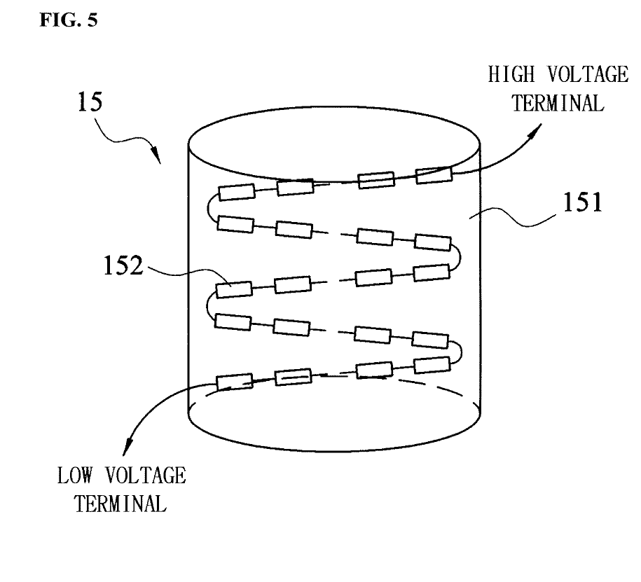

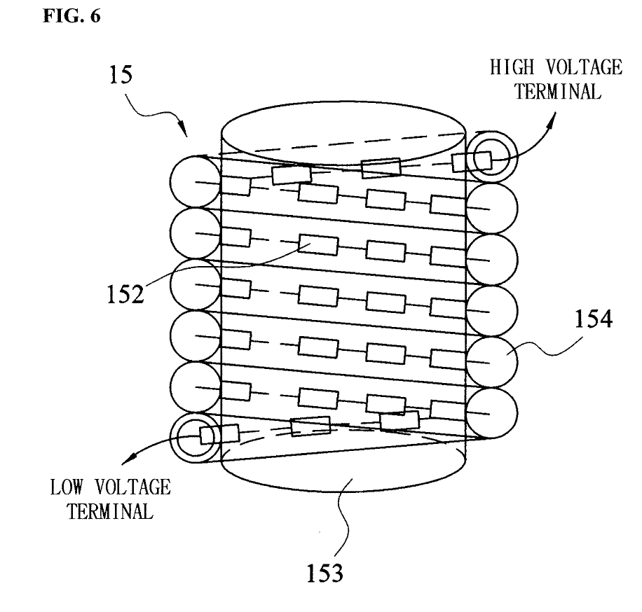

FIG. 5 is a view illustrating a resin-molded resistive voltage sensor (15) according to the embodiment of the present invention, and FIG. 6 is a view illustrating a resistive voltage sensor in the form of an insulation tube according to the embodiment of the present invention.

Generally, an inductive voltage transformer (PT) is used to detect a voltage signal. However, there are many problems such as a big size, a high expense, and use of a fuse and the inductive voltage transformer is not proper to manufacture a sensor-integrated circuit breaker. A capacitive voltage sensor using the static induction of a voltage is conveniently manufactured and high insulation strength is easily obtained, but the capacitive voltage sensor is variable with respect to frequency and temperature, so it has a limit of accurate voltage sensing.

A resistive potential divider is a classical technique and a high precision sensor can be integrated therein. However, a point is how small the sensor is integrated in the circuit breaker. When considering the point, the insulation must be considered and the static induction must be effectively shielded or compensated.

The resistive voltage sensor (15) according to the embodiment of the present invention, as illustrated in FIGS. 5 and 6, is realized by resistors (152) connected in series between a high voltage terminal and a low voltage terminal. The series resistors (152) may be wound around a bushing in the circuit breaker case, may be wound around a cylindrical insulator in a spiral shape, and may be inserted into and sealed by an insulator such as an epoxy. The resistive voltage sensor (15) enables the insulation strength and the minimization.

The resistive voltage sensor (15) in FIG. 5 is configured that the spiral resistors (152) are inserted into and are sealed by an insulator (151), and the resistive voltage sensor (15) in FIG. 6 is configured that the resistors (152) are connected to each other in series to be accommodated in an insulating tube (154). As such, the resistive voltage sensors (15) according to the embodiment of the present invention are wound in the spiral shape to extend their lengths and SF6 gas in the tube (154) serves to as insulator.

According to the present invention, when the resistive voltage sensor (15) is manufactured, small-size resistors are connected to each other in series to be wound in the form of a circular shape, a rectangular shape, and the like and to be insulated to manufacture the same in a small size, so that the insulation is easily secured and a high precision voltage sensor can be manufactured.

When the resistors are located at a conductor such as a bushing to which a voltage is applied, a static voltage is induced and a phase is transited. This can be easily compensated during the estimation while driving a general analog phase transition circuit or a digital filter.

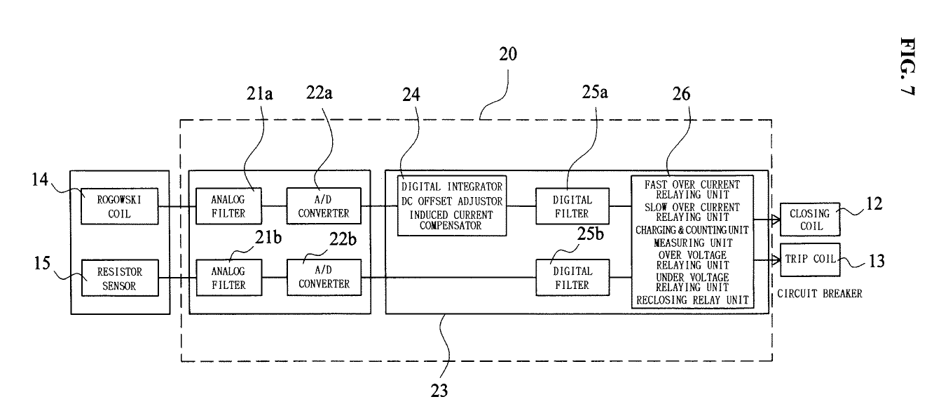

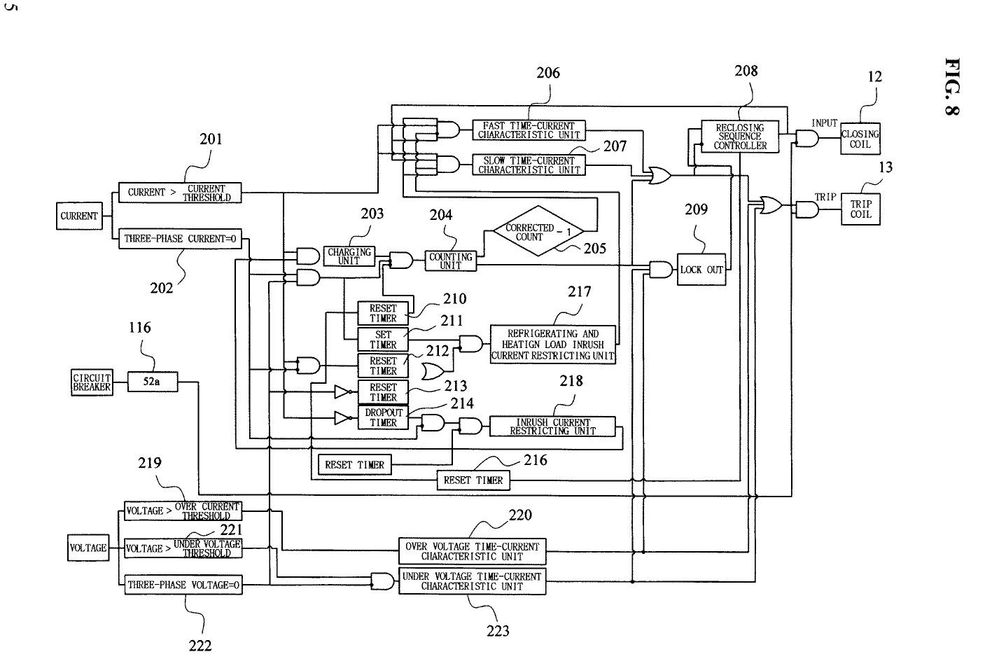

FIG. 7 is a block diagram illustrating the circuit breaker according to the embodiment of the present invention, and FIG. 8 is a protection coordination algorithm for improving the cooperative operation of the circuit breaker according to the embodiment of the present invention with the recloser.

Generally, a protecting device of a distribution line includes a circuit breaker of an electric power substation, a recloser of a line, a sectionalizer, a customer fuse, a customer circuit breaker, and a combination of the customer fuse and a customer automatic section switch. The recloser is a circuit breaker in which a fast operation and a delay operation are combined by considering a point that failure of the distribution line is approximately 80% transient fault, and is cooperated with a load fuse and the circuit breaker when a delay operation is performed.

In actual situation, for the purpose of the coordination with the circuit breaker of the electric power substation, the recloser of the line, and the fuse or the circuit breaker of the customer, an operation time limit is set by “a response time of the circuit breaker of the electric power substation>a fault clearing time of the recloser, a response time of the recloser>a fault clearing time of the fuse or the circuit breaker of the customer”. However, the coordination is frequently impossible because the response time of the circuit breaker of the electric power substation is adjusted faster. There is the sectionalizer or the automatic section switch as a device to solve the problem. Since this device memorizes the fault current and is opened to separate the fault section after a backup recloser or the circuit breaker of the electric power substation clears the fault, the device is available when the coordination in view of the time limit is difficult.

However, since the sectionalizer and the automatic section switch cooperate with the backup protection device by performing a counting function and are fundamentally opened after the backup protection device operates, there is a drawback of transiently propagating a fault in the customer to the line. When the automatic section switch receives the electric power, the fault is cleared anyhow after the backup protection device is operated once. However, when the circuit breaker is used as a formal power receiving unit, a backup recloser cooperates with the delay operation at least after finishing an instantaneous operation or is frequently locked out to be developed to a permanent fault state.

When the metering out fit (MOF) is installed to a power supply side of the circuit breaker, the power receiving unit of the customer is protected again by the power fuse. Since the capacity of the power fuse increases, the coordination with the recloser is difficult. In order to solve this problem, instead of the disconnect switch (DS) installed at a point of responsibility division of the customer, the sectionalizer or the automatic section switch is installed. Consequently, this is to clear the fault section using the counting function and the charging function, and thus makes the circuit breaker into a useless thing and causes undesired costs.

Moreover, a three-phase transformer is installed for the loss of phase protection and an undervoltage relay opens the circuit breaker when the loss of phase is occurred. Since the circuit breaker is opened when a predetermined time lapses even a case when the loss of phase is not occurred but a permanent failure is occurred in a backup system, the customer checks whether or not own devices are out of order one by one at the moment of repressing and inputs electric power so that undesired time and power interruption time are extended.

The present invention provides a new algorithm of combining a conventional overcurrent relay with a conventional undervoltage relay in order to solve the problem. Moreover, when the distribution line is long, another recloser is added to coordinate serially. However, as described above, since there is no enough coordination time, it is available to coordinate through the counting function of the sectionalizer.

However, although the backup protection device must wait for the backup protection device to clear the fault because the sectionalizer is basically a load switch, the circuit breaker can reduce the number of the power interruption for the clearance of the fault and can provide a stable and improved coordination for the protection of the distribution line in comparison to the sectionalizer. Since the circuit breaker provides the activated function of the overcurrent relay by times less by one than corrected counts in the sequence, the series coordination of the automatic section circuit breaker is possible and the number of the power interruption can be reduced in comparison to the sectionalizer.

The circuit breaker according to the embodiment of the present invention to solve the above-mentioned problem, as illustrated in FIG. 7, includes a Rogowski coil (14) integrally formed with a circuit breaker main body (10) to detect current, a resistive voltage sensor (15) to detect voltage, analog filters (21a and 21b), analog-to-digital converters (22a and (22b), a preprocessing unit (24) to perform a digital integration of the detected current converted into the digital value, an adjustment of a DC offset, and a compensation of an induced current, a digital filter (25a) to filter the pre-processed current value, a digital filter (25b) to filter the voltage value converted into a digital value, and a control unit (26) to control a closing coil (12) and a trip coil (13) by comparing the filtered current value with a current threshold value and the filtered voltage value with an overvoltage threshold value or an undervoltage threshold value, and by processing a fast overcurrent relaying function, a delay overcurrent relaying function, a charging and counting function, a measuring function, an overcurrent relaying function, an undervoltage relaying function, and a reclosing relaying function. Here, the preprocessing unit (24), the digital filters (25a and (25b), and the control unit (26) are preferably realized by a microprocessor and a software.

The principal control algorithm processed by the microprocessor within the circuit breaker according to the embodiment of the present invention will be described as follows.

1. When the fault current is occurred and current detected by the Rogowski coil (14) is greater than the current threshold value and is determined as the fault current, one end of an output is inputted to timing circuits of an overcurrent relay and an overcurrent ground relay and the other one of the output is inputted to a charging function unit and a counting function unit.

2. The outputs of the timing circuits are transmitted to a trip function unit of the circuit breaker to open the circuit breaker and are inputted to a reclosing sequence controller.

3. When the fault current is cleared by the backup protection unit prior to the output of the timing circuits, the counting is performed once. When the fault continues and the counting is corrected, the corrected counted number is transmitted to the trip function unit and the circuit breaker is opened and locked out. This function has no relation with the reclosing function unit.

4. The overcurrent relaying function unit and the overcurrent ground relaying function are activated at the counting less by one than the corrected counting, for example, are activated at the counting 0 (zero) when the counting is corrected once, at the counting 1 when the counting is corrected twice, and at the counting 2 when the counting is corrected three times.

5. The overcurrent relaying function unit and the overcurrent ground relaying function unit have two fast and delay time-current characteristic curves. A fast characteristic is similar to the fastest one among fast time-current characteristic curve group in relation with the recloser. In this case, when the recloser corrects a slightly delayed fast time-current characteristic curve from the fast time-current characteristic curve group according to a minimal response characteristic, the circuit breaker according to the embodiment of the present invention can clear the fault before the recloser is operated when the fault is occurred in the customer without damaging the coordination between the circuit breaker of the electric power substation and the recloser and can fundamentally prevent the fault in the customer from being propagated to the line. The delay time-current characteristic is activated only when preventing a cold load pickup is activated.

6. The cold load pickup preventing function is activated when a non-voltage state lasts for a predetermined time and is compelled to be reset when a normal current flows or after a predetermined time lapses.

7. The charging function is activated when an inrush current restraint function unit is not activated and prevents the backup protection unit from malfunctioning due to the reclosing of the backup protection unit when the power supply is malfunctioned. The inrush current restraint function is activated when a load current is experienced before the fault is cleared by the backup protection unit, and increases a minimal working current or restricts the detection of the minimal working current for a predetermined time. The inrush current restraint function is reset when the load current flows for a predetermined time after repressing.

8. The undervoltage relaying function and the overvoltage relaying function are combined with the overcurrent relaying function and the overcurrent ground relaying function and the non-voltage opening is provided to the undervoltage relaying function.

9. The reclosing relaying function coordinates with only the overcurrent relaying function and the overcurrent ground relaying function and is not coupled with the counting function and the reclosing relaying function. The overvoltage relaying function and the undervoltage relaying function can be independently inactivated.

Next the control algorithm of the circuit breaker according to the embodiment of the present invention will be described with reference to FIG. 8 as follows.

When the line current detected by the Rogowski coil (14) is greater than the current threshold value (201), the output value of the Rogowski coil (14) is inputted to the fast time-current characteristic unit (206) and the delay time-current characteristic unit (207), and simultaneously is inputted to a charging unit (203) to prepare the counting.

When the fault is continued and the fast time-current characteristic unit (206) and the delay time-current characteristic unit (207) output, one of the outputs excites the trip coil (13) to open the contact of the circuit breaker and the other one is inputted the reclosing sequence controller (208) so that the sequence is developed from the reset state to a cycle state.

If the fault is cleared and reaches normal current state, a reset timer (216) resets the reclosing sequence controller (208). If the fault is cleared by the backup protection unit, an output of the charging unit (203) is inputted to the counting unit (204) at the moment when the three-phase current is 0 (zero) (202) so that the counting is performed. When the counting reaches the corrected count by repeating the process, the contact of the circuit breaker is opened and the reclosing sequence controller (208) is locked out.

The fast time-current characteristic unit (206) and the delay time-current characteristic unit (207) are activated when the count is less by one than the corrected count. For example, the fast time-current characteristic unit and the delay time-current characteristic unit works similar to the conventional circuit breaker when the count is corrected to one at the end of the line such as the customer, perform only one count when the count is corrected to two, and works as a circuit breaker when the fault is occurred twice.

Particularly, a high speed automatic circuit breaker of the present invention must work faster than the fast operation of the recloser and has a very fast operation characteristic. Due to this characteristic, the automatic circuit breaker may be malfunctioned due to the inrush current (217) caused by refrigerating and heating loads. In order to solve the problem, the automatic circuit breaker has the fast and delay time-current characteristics, and the delay time-current characteristic unit (207) is activated at the moment when the power interruption continues for a predetermined time and the refrigerating and heating load break the balance.

A refrigerating and heating load inrush current restricting unit (217) is activated by a set timer (211) when a three-phase current is 0 (202) and a three-phase voltage is 0 (222), and is compulsorily reset due to an output of a reset timer (212) when the three-phase current is normal or by a reset timer (213) when the three-phase voltage is not 0.

An inrush current restraint function unit (218) is provided to prevent a counting error caused by the reclosing of the backup protection unit when the power supply is malfunctioned, and is activated by a dropout timer (214) and the following logic when the three-phase current is normal at the moment when the three-phase current is 0 (202). When the inrush current restraint function unit (218) is activated, the function of the charging unit (203) is restricted and the inrush current restraint function unit (218) is inactivated by a reset timer (215) at the normal current state.

The undervoltage time-voltage characteristic unit (223) does not function when the three-phase voltage is 0 (222).

The reclosing sequence controller (208) is operated only by the overcurrent relaying units (206 and 208), and the charging counting trip and a trip caused by the overvoltage relaying units (220 and 223) directly lock out the circuit breaker.

1. A high speed automatic circuit breaker comprising:
a circuit breaker main body to receive an electric power when a fixed contact and a moving contact each other, including a Rogowski coil to detect current and a resistive voltage sensor to detect voltage which are integrally formed with the circuit breaker main body, to operate the moving contact using an trip coil according to a trip control signal to trip, and to operate the moving contact to input the electric power according to an closing control signal; and
circuit breaker control unit to receive a current detection signal for the current flowing through a lead-in line from the Rogowski coil and to receive a voltage detection signal of the lead-in line from the resistive voltage sensor to generate a control signal for controlling the circuit breaker main body, and
having a counting function, a charging function and a trip function, added to a general overcurrent relaying function, a general overcurrent ground relaying function, a general reclosing relaying function, a general overvoltage relaying function, and a general undervoltage relaying function.

2. The high speed automatic circuit breaker according to claim 1, wherein the Rogowski coil includes an end of a coil wound around a plastic core to return through a groove formed in the plastic core, and the coil has an outer side magnetically shielded and an inner side electrically shielded.

3. The high speed automatic circuit breaker according to claim 1, wherein the resistive voltage sensor is configured that small sized resistors are connected to each other in series and the sequence of the resistors is wound around an outer side of a bushing or an insulator for the insulation, and the insulator comprises an insulation tube or a molded resin.

4. The high speed automatic circuit breaker according to claim 1, wherein the circuit breaker control unit comprises:
an analog filter to filter a current detected in the circuit breaker main body;
an analog-to-digital converter to convert the detected analog signals into digital signals;
a preprocessing unit to perform a digital integration of the detected current converted into the digital detected current, an adjustment of a DC offset, and a compensation of an induced current;
a digital filter unit to filter the preprocessed current value;
an analog filter to filter a voltage detected in the circuit breaker main body;
an analog-to-digital converter to convert the analog detected voltage into a digital detected voltage;
a digital filter to filter the detected voltage converted into the digital value; and
a controller to compare the filtered current with a current threshold value and the filtered voltage with an overvoltage threshold value to perform a fast overcurrent relaying function, a delay overcurrent relaying function, a charging and counting function, a measuring function, an overvoltage relaying function, an undervoltage relaying function, and a reclosing relaying function, and
provides the counting function, the charging function, and the trip function to the general overcurrent relaying function, the general overcurrent ground relaying function, the general reclosing relaying function, the general overvoltage relaying function, and the general under-voltage relaying function so as to take the place of coordinate with a recloser in a line without installing a sectionalizer or an automatic section switch.

5. The high speed automatic circuit breaker according to claim 4, wherein the preprocessing unit compensates a phase with a digital filter without using a digital integrator.

6. The high speed automatic circuit breaker according to claim 4, wherein the controller provides fast and delay time-current characteristic curves different from each other to the overcurrent relaying function unit, the fast time-current characteristic coordinates with a fast time-current characteristic of the recloser, and the delay time-current characteristic prevents a cold load pickup such that the overcurrent relaying function is activated at a sequence previous by one to a corrected count.

7. The high speed automatic circuit breaker according to claim 4, wherein the controller inputs an output to the overcurrent relaying unit when a fault occurs to generate a current higher than a minimal working current and input another output to the counting function unit to transmit a trip signal when the time-current characteristic of the overcurrent relaying function unit is completed, performs the counting when the fault is eliminated before the time-current characteristic of the overcurrent relaying function unit is completed, resets a count when a system is returned to a normal state, activates an inrush current restricting function of the counting function to blunt or restrict a fault detection for a predetermined time when the counting function has an inrush current restricting algorithm and the current disappears at the normal current state, and returns the normal fault detection when a normal current flows for a predetermined time or after a correction time lapses.

8. The high speed automatic circuit breaker according to claim 4, wherein the controller inactivates the undervoltage relaying function at a non-three-phase voltage and associates the reclosing relaying function with the overcurrent relaying function only when the overcurrent relaying function and the undervoltage relaying function are provided.
